(19) United States
(12) Patent Application Publication
(10) Pub. No.: US 2023/0175580 A1
(43) Pub. Date: Jun. 8, 2023

(54) LUBRICATION STRUCTURE OF TORQUE VECTORING APPARATUS

(71) Applicants: Hyundai Motor Company, Seoul (KR); Kia Corporation, Seoul (KR)

(72) Inventors: Chulmin AHN, Anyang-si (KR); Baekyu KIM, Hwaseong-si (KR); SungGon BYUN, Hwaseong-si (KR); Junyoung HA, Anyang-si (KR); Dong Hui CHEON, Hwaseong-si (KR); Jieun KIM, Suwon-si (KR); Yohan KIM, Busan (KR); Sun Sung KWON, Anygan-si (KR); Su Hyeon MAENG, Seoul (KR)

(21) Appl. No.: 17/732,116

(22) Filed: Apr. 28, 2022

(30) Foreign Application Priority Data
Dec. 3, 2021 (KR) 10-2021-0171608

(51) Int. Cl. F16H 57/04

(52) U.S. Cl. CPC F16H 57/0421; F16H 57/0479; F16H 57/0483; F16H 48/36

(57) ABSTRACT

An exemplary lubrication structure of a torque vectoring apparatus includes an axle housing including left-side and right-side housings disposed on left and right sides of a differential device, a left-side cover provided on an external side of the left-side housing, and a right-side cover provided on an external side of the right-side housing, where, a first space is formed between the left-side and right-side housings and provided with the differential therein, a second space is formed between the left-side housing and the left-side cover and provided with a first planetary gear set, a third space is formed between the right-side housing and the right-side cover and provided with second and third planetary gear sets, and the first, second, and third spaces are fluidically partitioned by a plurality of oil seals, and respectively filled with a lubrication oil therein.

### CROSS-REFERENCE TO RELATED APPLICATION

The present application claims priority to Korean Patent Application No. 10-2021-0171608 filed on Dec. 3, 2021, the entire contents of which is incorporated herein for all purposes by this reference.

### BACKGROUND OF THE PRESENT DISCLOSURE

### Field of the Present Disclosure

The present disclosure relates to a lubrication structure of a torque vectoring apparatus.

### Description of Related Art

In general, a torque vectoring apparatus is a device that can independently control torques transmitted to left-side and right-side drive wheels to improve agility and handing performance of a vehicle.

Here, the term “torque vectoring” refers to controlling the magnitude and the direction of an overall torque applied to a vehicle, of which an example is that a distribution ratio of a driving torque output from an engine and supplied to drive wheels is controlled, facilitating respective driving wheels to receive driving torques controlled by the torque vectoring technology.

Such a torque vectoring may be realized as an additional function of a differential device that receives an engine torque and distributes the engine torque to left-side and right-side drive wheels.

A differential device provided with the torque vectoring function may actively control a torque distribution ratio of left-side and right-side drive wheels to satisfy intention of a driver or to enhance dynamics of a vehicle depending on driving circumstances.

FIG. 1 is a schematic diagram of an example of a general torque vectoring apparatus.

Referring to FIG. 1, a torque vectoring apparatus includes a motor-generator MG as a driving power source, a speed reduction device 10, a differential device 20, a torque vectoring apparatus 30 controlled by a torque vectoring control motor TVCM, and a torque multiplication device 40. The differential device 20, the torque vectoring apparatus 30, and the torque multiplication device 40 are disposed on an axis of left-side and right-side output shafts OS1 and OS2.

In the torque vectoring apparatus, a rotation speed of the motor-generator MG is reduced in the speed reduction device 10, and the reduced speed is transmitted to the differential device 20. The differential device 20 receives a torque from the speed reduction device 10 and transmits the received torque to left-side and right-side drive wheels while absorbing a speed difference between the left-side and right-side drive wheels.

The torque vectoring apparatus 30 adjusts a torque ratio split to the left-side and right-side drive wheels by use of a torque of the torque vectoring control motor TVCM delivered from the torque multiplication device 40 according to driving conditions such as cornering or driving in a straight line, and thereby improves driving performance such as a cornering performance and the like of a vehicle.

In such a torque vectoring apparatus, the differential device 20 includes a differential case DC receiving a torque from the speed reduction device 10 through a final gear FG, and a differential DIFF disposed between two planetary gear sets PG1 and PG2 of the torque vectoring apparatus 30.

Furthermore, the torque vectoring apparatus 30 includes a combination of first and second planetary gear sets PG1 and PG2 interposing the differential device 20. The first planetary gear set and the second planetary gear set PG1 and PG2 receives the torque of the torque vectoring control motor TVCM through the torque multiplication device 40, and transmits the received torque to the left-side and right-side output shafts OS1 and OS2 through the differential device 20.

Furthermore, the torque multiplication device 40 includes a third planetary gear set PG3 disposed between the torque vectoring apparatus 30 and the torque vectoring control motor TVCM.

That is, the third planetary gear set PG3 multiplies the torque received from the torque vectoring control motor TVCM, and transmits the multiplied torque to the second planetary gear set PG2 of the torque vectoring apparatus 30.

In such a torque vectoring apparatus, the differential DIFF of the differential device 20 and the first planetary gear set and the second planetary gear set PG1 and PG2 of the torque vectoring apparatus 30, and the third planetary gear set PG3 of the torque multiplication device 40 are disposed on the axis of the left-side and right-side output shafts OS1 and OS2, and are lubricated by a churning oil.

However, in such a torque vectoring apparatus, the differential DIFF and the first, second, and third planetary gear sets PG1, PG2, and PG3 within an axle housing H are lengthily disposed in a width direction of the vehicle on the axis of the left-side and right-side output shafts OS1 and OS2. In the instant case, at a cornering of a vehicle, the churning lubrication oil may be excessively tilted toward an external side of the cornering.

In the instant case, when the vehicle is cornering, the lubrication at the internal side of the cornering within the axle housing H may become insufficient due to insufficient oil, and churning loss may occur at an opposite side of the cornering direction within the axle housing H due to excessive oil.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a lubrication structure of a torque vectoring apparatus of lubricating a differential of a differential device, first and second planetary gear sets of a torque vectoring apparatus, and a third planetary gear set of a torque multiplication device that are disposed on an axis of first and second output shafts. The lubrication structure includes an axle housing including first and second housings disposed on first and second sides of the differential device, a first cover provided on an external side of the first housing, and a second cover provided on an external side of the second housing. Here, a first space is formed between the first housing and the second housing and provided with the differential therein, a second space is formed between the first housing and the first cover and provided with the first planetary gear set therein, a third space is formed between the second housing and the second cover and provided with the second planetary gear set and the third planetary gear set therein, and the first, second, and third spaces are fluidically partitioned by a plurality of oil seals, and respectively filled with a lubrication oil therein.

The first space may be fluidically partitioned by: a first oil seal provided between the first housing and a first connecting member that connect a first side gear of the differential to a first planet carrier of the first planetary gear set, and a second oil seal provided between the second housing and a second connecting member that connect a second side gear of the differential to a second planet carrier of the second planetary gear set.

The second space may be fluidically partitioned by a first oil seal provided between the first housing and a first connecting member that connect a first side gear of the differential to a first planet carrier of the first planetary gear set, and a third oil seal provided between the first output shaft and the first cover.

The third space may be fluidically partitioned by a second oil seal provided between the second housing and a second connecting member that connect a second side gear of the differential to a second planet carrier of the second planetary gear set, and a fourth oil seal provided between the second output shaft and the second cover.

The first space may be partitioned more air-tightly from the second space by a first sealing ring provided between the first connecting member and a connection shaft which is provided to penetrate the differential to connect first and second sun gears of the first planetary gear set and the second planetary gear set. The first space may be partitioned more air-tightly from the third space by a second sealing ring provided between the connection shaft and the second connecting member.

In the first planetary gear set, a hydraulic line penetrating a gear shaft of the first planet carrier in a radial direction may be formed, and an oil guider connected to the hydraulic line may be provided at a first end portion and a second end portion of the gear shaft.

In the second planetary gear set, a hydraulic line penetrating a gear shaft of the second planet carrier in a radial direction may be formed, and an oil guider connected to the hydraulic line may be provided at a first end portion and a second end portion of the gear shaft.

An oil separating plate may be provided on the second housing within the third space to fluidically separate the third planetary gear set from an input gear connected to an output gear on a motor shaft of a torque vectoring control motor through a torque transmission member.

In the third planetary gear set, a hydraulic line penetrating a gear shaft of a third planet carrier in a radial direction may be formed, and an oil guider connected to the hydraulic line may be provided on an end portion of the gear shaft.

Accordingly, according to a lubrication structure of a torque vectoring apparatus according to an exemplary embodiment of the present disclosure, by use of the oil seals and sealing rings, an internal space of the first housing and the second housing and the first and second covers is partitioned into the first space provided with the differential of the differential device, the second space provided with the first planetary gear set of the torque vectoring apparatus, and the third space provided with the second planetary gear set of the torque vectoring apparatus and the third planetary gear set of the torque multiplication device.

Accordingly, even if the lubrication oil is tilted toward the outside of the cornering at a cornering of a vehicle, it is possible to prevent insufficient oil or excessive oil depending on portions, facilitating fluent supply of the lubrication oil by churning to the planetary gear sets of the torque vectoring apparatus and the torque multiplication device.

Other effects which may be obtained or are predicted by an exemplary embodiment will be explicitly or implicitly described in a detailed description of the present disclosure. That is, various effects that are predicted according to an exemplary embodiment will be described in the following detailed description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic diagram of an example of a general torque vectoring apparatus.

FIG. 2 is a cross-sectional view of a torque vectoring apparatus applied with a lubrication structure according to an exemplary embodiment of the present disclosure.

FIG. 3 is a cross-sectional view showing a state of a torque vectoring apparatus of FIG. 2 filled with a lubrication oil.

FIG. 4 is an enlarged view of a portion A of FIG. 3.

FIG. 5 is an enlarged view of a portion B of FIG. 3.

FIG. 6 and FIG. 7 illustrate distribution of the lubrication oil in a torque vectoring apparatus by a lubrication structure of according to an exemplary embodiment of the present disclosure, when the vehicle is turning to the right.

FIG. 8 and FIG. 9 illustrate distribution of the lubrication oil in a torque vectoring apparatus by a lubrication structure of according to an exemplary embodiment of the present disclosure, when the vehicle is turning to the left.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

An exemplary embodiment will hereinafter be described in detail with reference to the accompanying drawings.

To clarify the present disclosure, parts that are not related to the description will be omitted, and the same elements or equivalents are referred to with the same reference numerals throughout the specification.

In the following description, dividing names of components into first, second, and the like is to divide the names because the names of the components are the same as each other and an order thereof is not particularly limited.

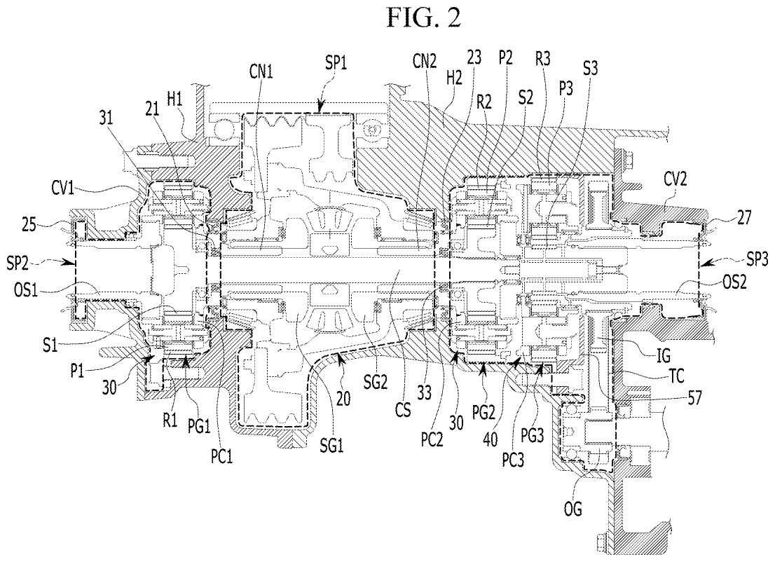

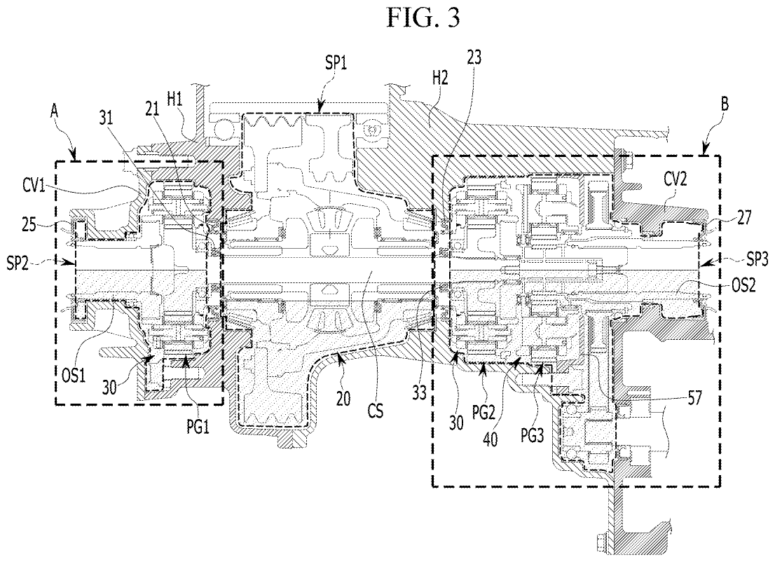

FIG. 2 is a cross-sectional view of a torque vectoring apparatus applied with a lubrication structure according to an exemplary embodiment of the present disclosure. FIG. 3 is a cross-sectional view showing a state of a torque vectoring apparatus of FIG. 2 filled with a lubrication oil.

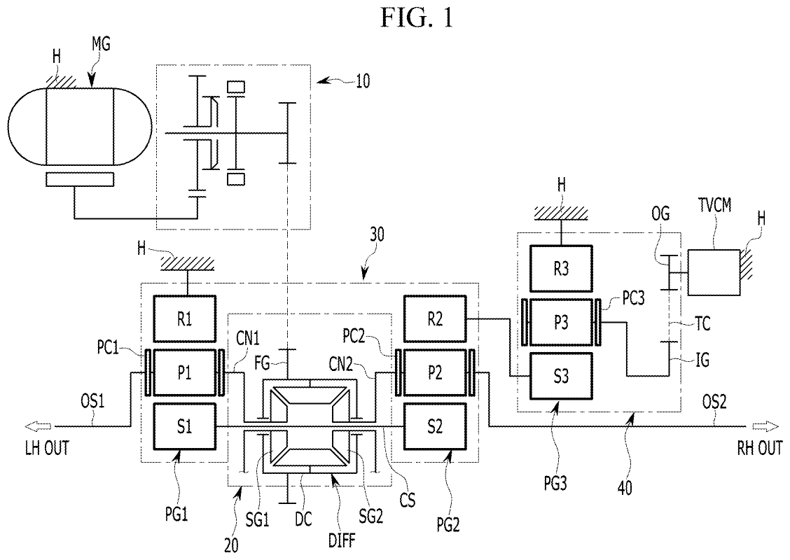

Referring to FIG. 1 to FIG. 3, a torque vectoring apparatus to which a lubrication structure according to an exemplary embodiment of the present disclosure is applied includes, within an axle housing H, a motor-generator MG as a driving power source, a speed reduction device 10, a differential device 20, a torque vectoring apparatus 30 controlled by a torque vectoring control motor TVCM, and a torque multiplication device 40. The differential device 20, the torque vectoring apparatus 30, and the torque multiplication device 40 are disposed on an axis of left-side and right-side output shafts OS1 and OS2.

Here, the axle housing H includes left-side and right-side housings H1 and H2 disposed on left and right sides of the differential device 20, a left-side cover CV1 is provided on an external side of the left-side housing H1, and a right-side cover CV2 is provided on an external side of the right-side housing H2.

In the torque vectoring apparatus, a rotation speed of the motor-generator MG is reduced in the speed reduction device 10, and the reduced speed is transmitted to the differential device 20 including a differential DIFF. The differential device 20 receives a torque from the speed reduction device 10 to and transmits the received torque to left-side and right-side drive wheels while absorbing a speed difference between the left-side and right-side drive wheels.

The torque vectoring apparatus 30 adjusts a torque ratio split to the left-side and right-side drive wheels by use of a torque of the torque vectoring control motor TVCM delivered from the torque multiplication device 40 according to driving conditions such as cornering or driving in a straight line, and thereby improves driving performance such as a cornering performance and the like of a vehicle.

The left-side and right-side output shafts OS1 and OS2 are power transmission shafts provided between the differential device 20 and the left-side and right-side drive wheels, and may imply typical left-side and right-side driveshafts.

The differential device 20 receives a torque from the speed reduction device 10 to and transmits the received torque to left-side and right-side drive wheels while absorbing a speed difference between the left-side and right-side drive wheels.

The differential device 20 includes a differential case DC receiving a torque from the speed reduction device 10 through a final gear FG, and a differential DIFF disposed between the two planetary gear sets PG1 and PG2 of the torque vectoring apparatus 30.

the torque vectoring control motor TVCM is provided on an external side of the right-side housing H2 through the right-side cover CV2, and an output gear OG is configured on a motor shaft of the torque vectoring control motor TVCM to output a torque.

The torque vectoring apparatus 30 adjusts a torque ratio between the left-side and right-side drive wheels by use of a torque received from the torque vectoring control motor TVCM, and includes first and second planetary gear sets PG1 and PG2.

The first planetary gear set and the second planetary gear set PG1 and PG2 is spaced apart interposing the differential DIFF of the differential device 20.

The first planetary gear set PG1 includes a first sun gear S1, a first planet carrier PC1 rotatably supporting a plurality of first pinion gears P1 gear-meshed with the first sun gear S1, and a first ring gear R1 internally gear-meshed with the plurality of first pinion gears P1.

The second planetary gear set PG2 includes a second sun gear S2, a second planet carrier PC2 rotatably supporting a plurality of second pinion gears P2 gear-meshed with the second sun gear S2, and a second ring gear R2 internally gear-meshed with the plurality of second pinion gears P2.

The torque multiplication device 40 may include a third planetary gear set PG3 disposed on an axis of the right-side output shaft OS2 between the torque vectoring apparatus 30 and the torque vectoring control motor TVCM.

The third planetary gear set PG3 includes a third sun gear S3, a third planet carrier PC3 rotatably supporting a plurality of third pinion gears P3 gear-meshed with the third sun gear S3, and a third ring gear R3 internally gear-meshed with the plurality of third pinion gears P3.

In such a torque vectoring apparatus, the differential DIFF of the differential device 20, the first planetary gear set and the second planetary gear set PG1 and PG2 of the torque vectoring apparatus 30, and the third planetary gear set PG3 of the torque multiplication device 40 are disposed on an axis of the left-side and right-side output shafts OS1 and OS2, and lubricated by a churning oil.

In a lubrication structure of a torque vectoring apparatus according to an exemplary embodiment of the present disclosure, a space of the axle housing H formed by the left-side and right-side housings H1 and H2 and the left-side and right-side covers CV1 and CV2 is fluidically partitioned by oil seals into a space for the differential DIFF of the differential device 20, a space for the first planetary gear set PG1 of the torque vectoring apparatus 30 disposed on a left side of the differential DIFF, and a space for the second planetary gear set PG2 of the torque vectoring apparatus 30 and the third planetary gear set PG3 of the torque multiplication device 40 disposed on a right side of the differential DIFF, and these spaces are respectively filled with a lubrication oil OL.

Accordingly, at a cornering of a vehicle, the lubrication oil OL may be fluently supplied to the planetary gear sets PG1, PG2, and PG3 of the torque vectoring apparatus 30 and the torque multiplication device 40, by churning.

A first space SP1 is formed between the left-side and right-side housings H1 and H2 and disposed with the differential DIFF, and a second space SP2 is formed between the left-side housing H1 and the left-side cover CV1 and disposed with the first planetary gear set PG1.

Furthermore, a third space SP3 is formed between the right-side housing H2 and the right-side cover CV2 and provided with the second planetary gear set and the third planetary gear set PG2 and PG3.

Accordingly, the first, second, and third spaces SP1, SP2, and SP3 are partitioned by the oil seals, and respectively filled with the lubrication oil OL so that the respective spaces SP1, SP2, and SP3 may be lubricated by churning of the lubrication oil OL.

First, the first space SP1 is formed between the left-side and right-side housings H1 and H2, and partitioned by first and second oil seals 21 and 23.

The first oil seal 21 is provided between the left-side housing H1 and a first connecting member CN1 that connect a left-side side gear SG1 of the differential DIFF to the first planet carrier PC1 of the first planetary gear set PG1.

The second oil seal 23 is provided between the right-side housing H2 and a second connecting member CN2 that connect a right-side side gear SG2 of the differential DIFF to the second planet carrier PC2 of the second planetary gear set PG2.

Furthermore, the second space SP2 is formed between the left-side housing H1 and the left-side cover CV1, and partitioned by the first oil seal 21 and a third oil seal 25.

The third oil seal 25 is provided between the left-side output shaft OS1 and the left-side cover CV1.

Furthermore, the third space SP3 is formed between the right-side housing H2 and the right-side cover CV2, and partitioned by the second oil seal 23 and a fourth oil seal 27.

The fourth oil seal 27 is provided between the right-side output shaft OS2 and the right-side cover CV2.

Here, the first space SP1 is partitioned more air-tightly from the second space SP2 by a first sealing ring 31 provided between the first connecting member CN1 and a connection shaft CS which is provided to penetrate the differential DIFF to connect the first and second sun gears S1 and S2 of the first planetary gear set and the second planetary gear set PG1 and PG2 at both end portions.

Furthermore, the first space SP1 is partitioned more air-tightly from the third space SP3 by a second sealing ring 33 provided between the connection shaft CS and the second connecting member CN2.

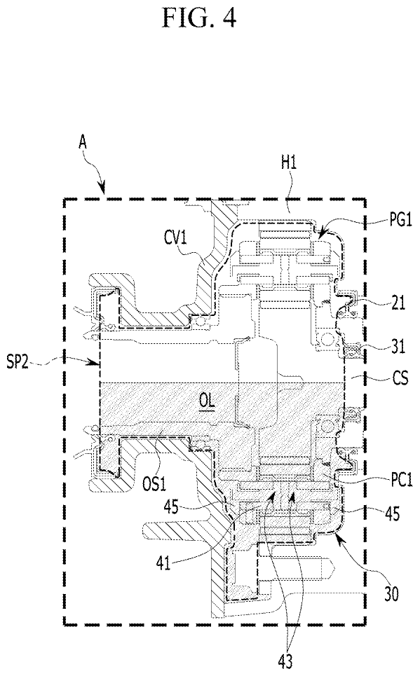

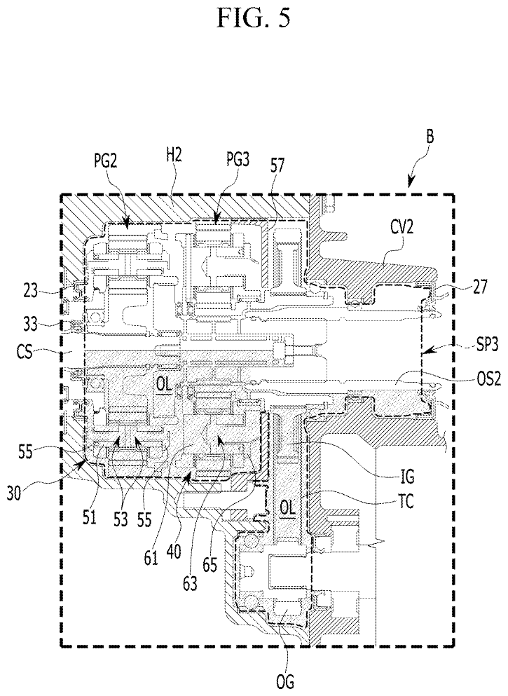

FIG. 4 is an enlarged view of a portion A of FIG. 3. FIG. 5 is an enlarged view of a portion B of FIG. 3.

Meanwhile, referring to FIG. 4, in the first planetary gear set PG1 within the second space SP2, a hydraulic line 43 penetrating a gear shaft 41 of the first planet carrier PC1 in radial direction is formed.

Furthermore, an oil guider 45 connected to the hydraulic line 43 is provided at both end portion of the gear shaft 41.

In the first planetary gear set PG1, even when the lubrication oil OL in the second space SP2 is tilted due to cornering of the vehicle, the oil guider 45 and the hydraulic line 43 formed at the gear shaft 41 of the first planet carrier PC1 positioned at a lower portion of the second space SP2 remain immersed in the lubrication oil OL.

Referring to FIG. 5, in the second planetary gear set PG2 within the third space SP3, a hydraulic line 53 penetrating a gear shaft 51 of the second planet carrier PC2 in radial direction is formed.

Furthermore, an oil guider 55 connected to the hydraulic line 53 is provided at both end portion of the gear shaft 51.

In the second planetary gear set PG2, even if the lubrication oil OL in the third space SP3 is tilted due to cornering of the vehicle, the oil guider 55 and the hydraulic line 53 formed at the gear shaft 51 of the second planet carrier PC2 positioned at a lower portion of the third space SP3 remain immersed in the lubrication oil OL.

Furthermore, an oil separating plate 57 is provided on the right-side housing H2 within the third space SP3.

The oil separating plate 57 separates the third planetary gear set PG3 from an input gear IG connected to the output gear OG on the motor shaft of the torque vectoring control motor TVCM through a torque transmission member TC and torque-connected to the third planetary gear set PG3 so that abrupt fluctuation of the lubrication oil OL may be suppressed.

Furthermore, in the third planetary gear set PG3 within the third space SP3, a hydraulic line 63 penetrating a gear shaft 61 of the third planet carrier PC3 in radial direction is formed.

Furthermore, an oil guider 65 connected to the hydraulic line 63 is provided on an end portion of the gear shaft 61.

In the third planetary gear set PG3, even if the lubrication oil OL in the third space SP3 is tilted due to cornering of the vehicle, the oil guider 65 and the hydraulic line 63 formed at the gear shaft 61 of the third planet carrier PC3 positioned at the lower portion of the third space SP3 remain immersed in the lubrication oil OL.

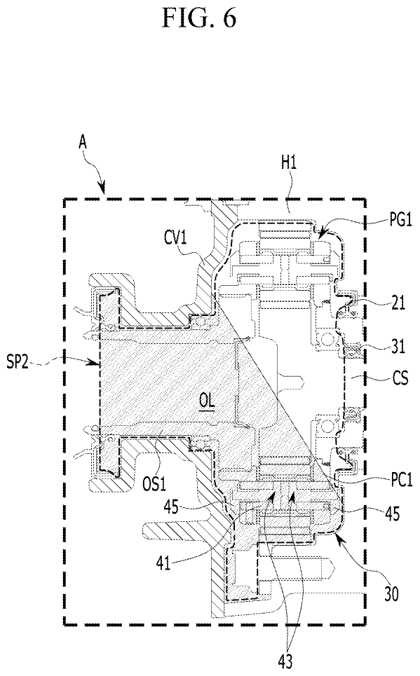

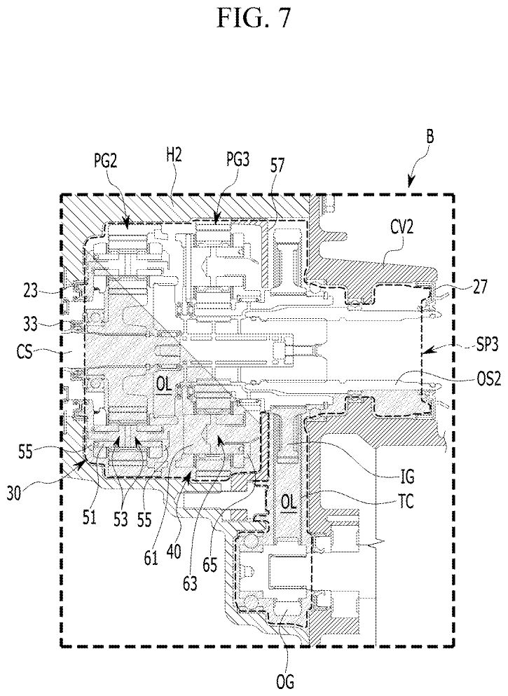

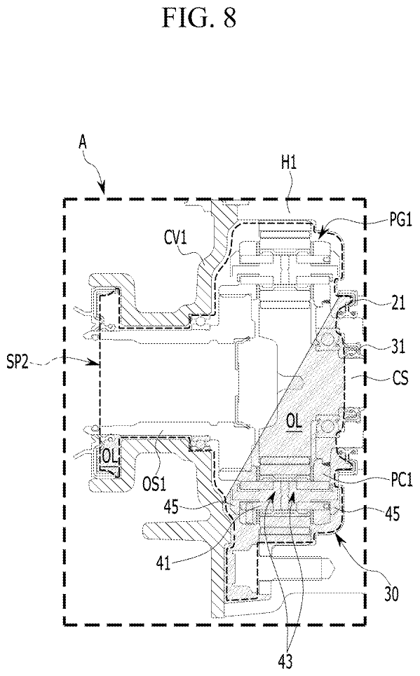

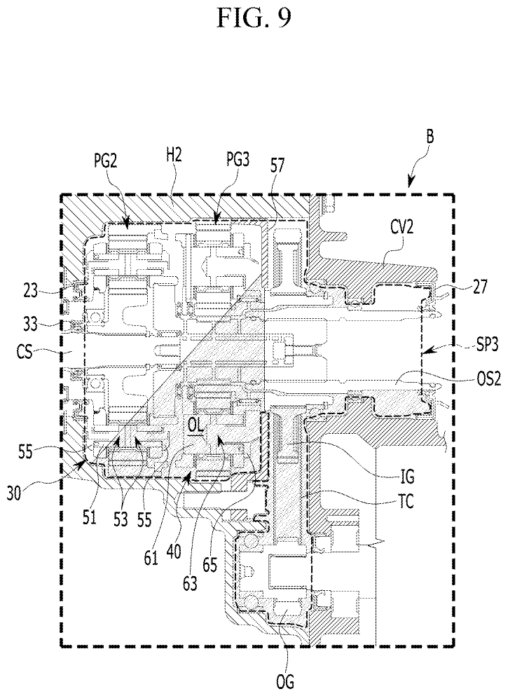

FIG. 6 and FIG. 7 illustrate distribution of the lubrication oil in a torque vectoring apparatus by a lubrication structure of according to an exemplary embodiment of the present disclosure, when the vehicle is turning to the right. FIG. 8 and FIG. 9 illustrate distribution of the lubrication oil in a torque vectoring apparatus by a lubrication structure of according to an exemplary embodiment of the present disclosure, when the vehicle is turning to the left.

Hereinafter, referring to FIG. 6 to FIG. 9, distribution of the lubrication oil according to a lubrication structure of a torque vectoring apparatus according to an exemplary embodiment of the present disclosure is described with respect to various cornering situations of the vehicle.

Referring to FIG. 6, when the vehicle is turning to the right, the lubrication oil OL in the second space SP2 is tilted to the left. At the instant time, in the first planetary gear set PG1, the hydraulic line 43 and the oil guider 45 formed at the gear shaft 41 of the first planet carrier PC1 positioned at the lower portion of the second space SP2 remain immersed in the lubrication oil OL, facilitating lubrication by churning.

Furthermore, referring to FIG. 7, the lubrication oil OL in the third space SP3 is also tilted to the left. At the instant time, in the second planetary gear set and the third planetary gear set PG2 and PG3, the hydraulic lines 53 and 63 and the oil guiders 55 and 65 formed at the gear shafts 51 and 61 of the second and third planet carriers PC2 and PC3 positioned at the lower portion of the third space SP3 remain immersed in the lubrication oil OL, facilitating lubrication by churning.

Referring to FIG. 8, when the vehicle is turning to the left, the lubrication oil OL in the second space SP2 is tilted to the right. At the instant time, in the first planetary gear set PG1, the hydraulic line 43 and the oil guider 45 formed at the gear shaft 41 of the first planet carrier PC1 positioned at the lower portion of the second space SP2 remain immersed in the lubrication oil OL, facilitating lubrication by churning.

Furthermore, referring to FIG. 9, the lubrication oil OL in the third space SP3 is also tilted to the right. At the instant time, in the second planetary gear set and the third planetary gear set PG2 and PG3, the hydraulic lines 53 and 63 and the oil guiders 55 and 65 formed at the gear shafts 51 and 61 of the second and third planet carriers PC2 and PC3 positioned at the lower portion of the third space SP3 remain immersed in the lubrication oil OL, facilitating lubrication by churning.

Accordingly, according to a lubrication structure of a torque vectoring apparatus according to an exemplary embodiment of the present disclosure, by use of the oil seals 21, 23, 25, and 27 and sealing rings 31 and 33, an internal space of the left-side and right-side housings H1 and H2 and the left-side and right-side covers CV1 and CV2 is partitioned into the first space SP1 provided with the differential DIFF of the differential device 20, the second space SP2 provided with the first planetary gear set PG1 of the torque vectoring apparatus 30, and the third space SP3 provided with the second planetary gear set PG2 of the torque vectoring apparatus 30 and the third planetary gear set PG3 of the torque multiplication device 40.

Accordingly, even if the lubrication oil OL is tilted toward the outside of the cornering at a cornering of a vehicle, it is possible to prevent insufficient oil or excessive oil depending on portions, facilitating fluent supply of the lubrication oil OL by churning to the planetary gear sets PG1, PG2, and PG3 of the torque vectoring apparatus 30 and the torque multiplication device 40.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

Furthermore, the term of “fixedly connected” signifies that fixedly connected members always rotate at a same speed. Furthermore, the term of “selectively connectable” signifies “selectively connectable members rotate separately when the selectively connectable members are not engaged to each other, rotate at a same speed when the selectively connectable members are engaged to each other, and are stationary when at least one of the selectively connectable members is a stationary member and remaining selectively connectable members are engaged to the stationary member”.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A lubrication structure of a torque vectoring apparatus of lubricating a differential of a differential device, first and second planetary gear sets of a torque vectoring apparatus, and a third planetary gear set of a torque multiplication device that are disposed on an axis of first and second output shafts, the lubrication structure comprising:
an axle housing including first and second housings disposed on first and second sides of the differential device;
a first cover provided on an external side of the first housing; and
a second cover provided on an external side of the second housing,
wherein a first space is formed between the first housing and the second housing and provided with the differential therein,
wherein a second space is formed between the first housing and the first cover and provided with the first planetary gear set therein,
wherein a third space is formed between the second housing and the second cover and provided with the second planetary gear set and the third planetary gear set therein, and
wherein the first, second, and third spaces are fluidically partitioned by a plurality of oil seals, and respectively filled with a lubrication oil therein.

2. The lubrication structure of claim 1, wherein the first space is fluidically partitioned by:
a first oil seal provided between the first housing and a first connecting member that connect a first side gear of the differential to a first planet carrier of the first planetary gear set; and
a second oil seal provided between the second housing and a second connecting member that connect a second side gear of the differential to a second planet carrier of the second planetary gear set.

3. The lubrication structure of claim 1, wherein the second space is fluidically partitioned by:
a first oil seal provided between the first housing and a first connecting member that connect a first side gear of the differential to a first planet carrier of the first planetary gear set; and
a third oil seal provided between the first output shaft and the first cover.

4. The lubrication structure of claim 1, wherein the third space is fluidically partitioned by:
a second oil seal provided between the second housing and a second connecting member that connect a second side gear of the differential to a second planet carrier of the second planetary gear set; and
a fourth oil seal provided between the second output shaft and the second cover.

5. The lubrication structure of claim 2,
wherein the first space is partitioned air-tightly from the second space by a first sealing ring provided between the first connecting member and a connection shaft which is provided to penetrate the differential to connect a first sun gear of the first planetary gear set and a second sun gear of the second planetary gear set, and
wherein the first space is partitioned air-tightly from the third space by a second sealing ring provided between the connection shaft and the second connecting member.

6. The lubrication structure of claim 3, wherein, in the first planetary gear set,
a hydraulic line penetrating a gear shaft of the first planet carrier in a radial direction thereof is formed, and
an oil guider connected to the hydraulic line is provided at a first end portion and a second end portion of the gear shaft.

7. The lubrication structure of claim 4, wherein, in the second planetary gear set,
a hydraulic line penetrating a gear shaft of the second planet carrier in a radial direction thereof is formed, and
an oil guider connected to the hydraulic line is provided at a first end portion and a second end portion of the gear shaft.

8. The lubrication structure of claim 4, wherein an oil separating plate is provided on the second housing within the third space to fluidically separate the third planetary gear set from an input gear connected to an output gear on a motor shaft of a torque vectoring control motor through a torque transmission member.

9. The lubrication structure of claim 8, wherein, in the third planetary gear set,
a hydraulic line penetrating a gear shaft of a third planet carrier in a radial direction thereof is formed, and
an oil guider connected to the hydraulic line is provided on an end portion of the gear shaft.
